(19) United States
(12) Patent Application Publication
(10) Pub. No.: US 2013/0133633 A1
(43) Pub. Date: May 30, 2013

(54) REMOVAL APPARATUS FOR REMOVING UNBURNED DEPOSITS IN EGR FLOW PASSAGE OF VEHICLE

(71) Applicant: Suzuki Motor Corporation, Shizuoka (JP)

(72) Inventor: Shunsuke YAMANA, Shizuoka (JP)

(73) Assignee: SUZUKI MOTOR CORPORATION, Shizuoka (JP)

(21) Appl. No.: 13/687,280

(22) Filed: Nov. 28, 2012

(30) Foreign Application Priority Data
Nov. 29, 2011 (JP) 2011260302

(51) Int. Cl. F02M 25/07

(52) U.S. Cl. CPC F02M 25/0701
USPC 123/568.12

(57) ABSTRACT

There is provided a removal apparatus for removing unburned deposits in an EGR flow passage of a vehicle. A control device of the removal apparatus is provided with a deposit removal implementing unit. The EGR gas flow control valve flows a part of exhaust gas through the EGR flow passage in a case where the control device determines that a temperature of cooling water of an engine is equal to or more than a predetermined temperature. The deposit removal implementing unit implements removal of the unburned deposits in the EGR flow passage in a case where the control device determines that the engine is in a high-load condition while the exhaust gas flows in the EGR flow passage and that it is a deposit removal implementation timing.

### CROSS-REFERENCE TO RELATED APPLICATIONS

This application claims the benefit of Japanese Application No. 2011-260302, filed Nov. 29, 2011 in the Japanese Intellectual Property Office, the disclosures of which are incorporated herein by reference.

### BACKGROUND OF THE INVENTION

1. Field of the Invention

The present invention relates to a removal apparatus for removing unburned deposits in an EGR (Exhaust Gas Recirculation) flow passage of a vehicle. The vehicle includes the EGR flow passage for returning a part of exhaust gas from an engine to an intake part and an EGR cooler for cooling the exhaust gas flowing through the EGR flow passage.

2. Description of the Related Art

As one measure for improving fuel consumption of an engine mounted on a vehicle, there is a method for introducing a part of exhaust gas to an intake part by an EGR flow passage in a low-load condition of the engine. In this regard, recently, further fuel consumption improvement is increasingly demanded from the viewpoint of a global warming or economic efficiency, etc. Specifically, there are some demands for improvement of the fuel consumption by introducing exhaust gas to an intake part in a high-load condition of an engine as well as in the low-load condition thereof as in the prior art.

However, in order to increase the flow rate (EGR flow rate) of exhaust gas (EGR gas) introduced to the intake part in the high-load condition, it is necessary that an EGR cooler is provided on an EGR flow passage to efficiently cool the exhaust gas introduced to the intake part in the high-load condition. In this case, it is possible to meet the requirement for EGR gas introduction in the high-load condition. However, there is a problem that unburned deposits (deposit) due to unburned carbon hydride such as hydrocarbon tend to be deposited on EGR flow part since the temperature of EGR gas is supercooled by the EGR cooler.

Japanese Patent Application Publication No. 11-351073A (Patent Document 1) is well-known as prior art relating to the above deposit. According to Patent Document 1, a gas temperature sensor for measuring the temperature of EGR gas, an EGR flow control valve for adjusting the flow rate of the EGR gas and an EGR cooler for cooling the EGR gas are provided on an EGR flow passage which returns EGR gas to an intake part. Further, the EGR cooler and an engine are connected to each other by a cooling water circulation passage through which cooling water circulates between the EGR cooler and the engine. And, a cooling water flow control valve for adjusting the flow rate of the cooling water is provided on the cooling water circulation passage. In this way, according to Patent Document 1, the EGR flow control valve and the cooling water flow control valve are controlled by a control device so that the supercooling of EGR gas is prevented. Accordingly, it is possible to prevent deposit from being deposited in the EGR flow passage and to suppress the overheating of the cooling water.

Patent Document 1: Japanese Patent Application Publication No. 11-351073A

However, Patent Document 1 has a following problem.

It is effective to increase the temperature of exhaust gas in order to remove the deposit. However, since the temperature of EGR gas is adjusted through regulation of the flow rate of the cooling water in Patent Document 1, it is possible to decrease the temperature of the exhaust gas flowing through the EGR flow passage, but it is impossible to increase the temperature higher than the temperature of exhaust gas discharged. Further, it is impossible to increase the temperature of EGR gas in a short time only through the regulation of the flow rate of the cooling water.

Further, it is desired to remove the deposit in the EGR flow passage by rapidly increasing the temperature of EGR gas in accordance with the timing to increase the flow rate of EGR gas in a high-load condition of an engine, in addition to increasing the temperature of EGR gas to prevent the deposition of deposit in EGR flow passage as in Patent Document 1.

### SUMMARY OF THE INVENTION

Additional aspects and/or advantages of the invention will be set forth in part in the description which follows and, in part, will be obvious from the description, or may be learned by practice of the invention.

It is therefore an object of the present invention to provide a removal apparatus for removing unburned deposits in an EGR flow passage of a vehicle, which is capable of removing unburned deposits (deposit) that can be deposited in the EGR flow passage due to cooling of the exhaust gas by the EGR cooler.

In order to achieve the above object, according to a first aspect of the embodiments of the present invention, there is provided a removal apparatus for removing unburned deposits in an EGR flow passage of a vehicle, the EGR flow passage for returning a part of exhaust gas discharged from an engine to an intake part, the removal apparatus comprising: the intake part configured to pass therethrough air supplied from the outside of the vehicle to the engine; an exhaust part configured to pass therethrough the exhaust gas discharged from the engine; the EGR flow passage branched from the exhaust pat and configured to return the part of the exhaust gas discharged from the engine to the intake part; a water temperature sensor configured to detect a temperature of cooling water flowing in the engine; a rotational speed sensor configured to detect a rotational speed of the engine; an intake sensor configured to detect an intake air amount of the engine; an EGR gas flow control valve provided on the EGR flow passage and configured to adjust a flow rate of the exhaust gas flowing through the EGR flow passage; an EGR cooler provided on the EGR flow passage and configured to cool the exhaust gas flowing through the EGR flow passage; a cooling water circulation passage configured to circulate a part of cooling water for cooling the engine between the EGR cooler and the engine; a cooling water flow control valve provided on the cooling water circulation passage and configured to adjust a flow rate of the cooling water to the EGR cooler; and a control device provided with a deposit removal implementing unit configured to implement removal of deposits as the unburned deposits in the EGR flow passage at a predetermined timing and configured to: control the EGR gas flow control valve to flow the part of the exhaust gas through the EGR flow passage in a case where the control device determines that the temperature of the cooling water is equal to or more than a predetermined temperature; and control the deposit removal implementing unit to implement the removal of the deposits in a case where the control device determines that the engine is in a high-load condition while the exhaust gas flows in the EGR flow passage and that it is a deposit removal implementation timing.

According to the present invention, since the removal of deposit in the EGR flow passage is implemented in a high-load condition where the rotational speed of the engine is high or the intake air amount thereof is large, the flow rate of the exhaust gas flowing through the EGR flow passage is increased, as compared to a low-load condition of an engine. Accordingly, it is possible to effectively remove the deposit. Further, according to the present invention, it is possible to remove the deposit in the EGR flow passage at a desired timing.

### BRIEF DESCRIPTION OF THE DRAWINGS

These and/or other aspects and advantages of the invention will become apparent and more readily appreciated from the following description of the embodiments, taken in conjunction with the accompanying drawings which:

In the accompanying drawings:

FIG. 1 is a schematic view illustrating a system of a removal apparatus for removing unburned deposits in an EGR flow passage of a vehicle, according to an embodiment of the present invention.

FIG. 2 is a flowchart illustrating a control operation of a removal apparatus for removing unburned deposits in an EGR flow passage of a vehicle, according to the embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Hereinafter, an embodiment of the present invention will be described by referring to the accompanying drawings.

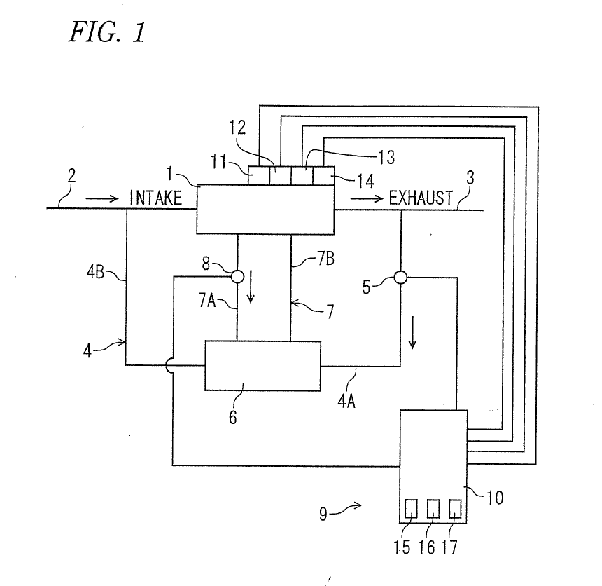

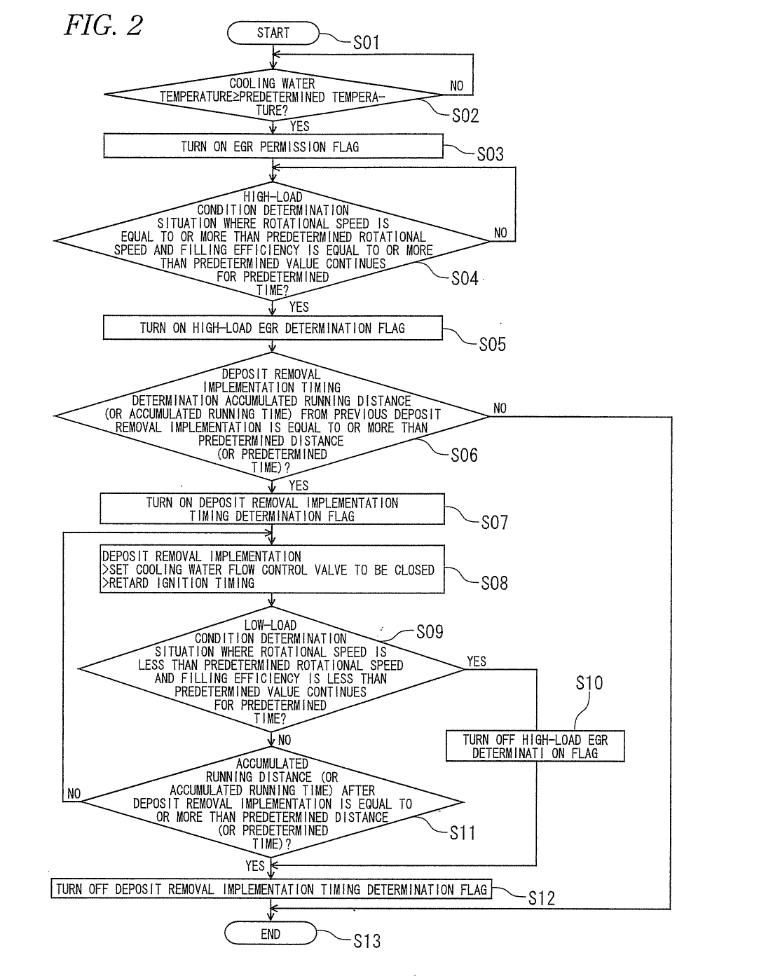

FIGS. 1 and 2 illustrate an embodiment of the present invention. In FIG. 1, reference numeral 1 represents an engine which is mounted on a vehicle, reference numeral 2 represents an intake passage which is an intake part and reference numeral 3 represents an exhaust passage which is an exhaust part. The engine 1 includes the intake passage 2 which is an intake part and the exhaust passage 3 which is an exhaust part. Air is supplied from the outside of a vehicle to each cylinder of the engine 1 and flows through the intake passage 2. Exhaust gas is discharged from each cylinder of the engine 1 and flows through the exhaust passage 3.

In order to improve fuel consumption, the engine 1 includes an EGR flow passage 4 which is branched from the exhaust passage 3 to return a part of the exhaust gas discharged from the engine 1 to the intake passage 2. An EGR gas flow control valve 5 for adjusting the flow rate of exhaust gas flowing through the EGR flow passage 4 and an EGR cooler 6 for cooling the exhaust gas flowing through the EGR flow passage 4 are provided on the EGR flow passage 4. The EGR flow passage 4 is composed of an exhaust side EGR flow passage 4A which is located closer to the exhaust passage 3 than the EGR cooler 6 and an intake side EGR flow passage 4B which is located closer to the intake passage 2 than the EGR cooler 6.

A cooling water circulation passage 7 for circulating a part of cooling water to cool the engine 1 between the EGR cooler 6 and the engine 1 is connected to the EGR cooler 6. The cooling water circulation passage 7 includes a supply side cooling water circulation passage 7A for supplying cooling water from the engine 1 to the EGR cooler 6 and a discharge side cooling water circulation passage 7B for returning the cooling water from the EGR cooler 6 to the engine 1. A cooling water flow control valve 8 for adjusting the flow rate of cooling water supplied to the EGR cooler 6 is provided in the supply side cooling water circulation passage 7A.

The EGR gas flow control valve 5 and the cooling water flow control valve 8 are connected to a control device 10 of a removal apparatus 9 for removing unburned deposits in the EGR flow passage. The removal apparatus 9 is adapted to remove deposit (unburned deposits due to unburned carbon hydride such as hydrocarbon) deposited in the EGR flow passage 4. The control device 10 includes a water temperature sensor 11 for detecting the temperature of cooling water flowing in the engine 1, a rotational speed sensor 12 for detecting the rotational speed of the engine 1, an intake sensor 13 for detecting the intake air amount of the engine 1 and an ignition timing retard means 14 for retarding the ignition timing of the engine 1.

The control device 10 includes a load condition determining means 15, a deposit removal implementation timing determining means 16 and a deposit removal implementing means 17.

The load condition determining means 15 determines that the engine 1 is in a high-load condition in a case where a situation where the rotational speed of the engine 1 is equal to or more than a predetermined rotational speed and a filling efficiency obtained from the intake air amount of the engine 1 is equal to or more than a predetermined value continues for a predetermined time. Further, the load condition determining means 15 determines that the engine 1 is in a low-load condition in a case where a situation where the rotational speed of the engine 1 is less than a predetermined rotational speed and a filling efficiency obtained from the intake air amount of the engine 1 is less than a predetermined value continues for a predetermined time.

The deposit removal implementation timing determining means 16 determines that it is a deposit removal implementation timing when an accumulated running distance or accumulated running time from previous deposit removal implementation is equal to or more than a predetermined distance or a predetermined time. The accumulated running distance or accumulated running time can be obtained from a rotational speed or a rotation time of a vehicle wheel, for example.

The deposit removal implementing means 17 implements removal of deposit in the EGR flow passage at a desired timing determined by the deposit removal implementation timing determining means 16. The deposit removal implementing means 17 implements at least one of a process for retarding the ignition timing of the engine 1 by the ignition timing retard means 14 or a process for decreasing the flow rate of cooling water supplied to the EGR cooler 6 by the cooling water flow control valve 8. The deposit removal implementing means 17 implements the removal of deposit in a state where the temperature of exhaust gas returned to the intake passage 2 is increased by jointly implementing the process for retarding the ignition timing of the engine 1 and the process for decreasing the flow rate of cooling water supplied to the EGR cooler 6.

The control device 10 opens the cooling water flow control valve 5 to supply a part of exhaust gas to the EGR flow passage 4 when it is determined that the temperature of cooling water detected by the water temperature sensor 11 is equal to or more than a predetermined temperature. Further, in a state where the exhaust gas is supplied to the EGR flow passage 4, the control device 10 actuates the deposit removal implementing means 17 to implement the removal of deposit when it is determined by the load condition determining means 15 that the engine 1 is in a high-load condition and when it is determined by the deposit removal implementation timing determining means 16 that it is the deposit removal implementation timing.

The deposit removal implementing means 17 implements at least one of a process for retarding the ignition timing of the engine 1 by the ignition timing retard means 14 or a process for decreasing the flow rate of cooling water supplied to the EGR cooler 6 by the cooling water flow control valve 8.

Next, an operation of the present embodiment will be described.

In FIG. 2, as a control programs is started (step S01), the removal apparatus 9 for removing unburned deposits in the EGR flow passage determines whether the temperature of cooling water is equal to or more than a predetermined temperature or not (step S02). The predetermined temperature is a temperature for initiating supply of the exhaust gas to the intake passage 2.

If “NO” is determined in step S02, the step S02 is repeated. If “YES” is determined in step S02, an EGR permission flag for allowing supply of exhaust gas to the intake passage 2 is turned ON (step S03). Then, the EGR gas flow control valve 5 is opened to supply the exhaust gas to the EGR flow passage 4 and then it is determined whether the engine 1 is in a high-load condition or not (step S04). Here, the high-load condition refers to a condition in which a situation where the rotational speed of the engine 1 is equal to or more than a predetermined rotational speed and a filling efficiency is equal to or more than a predetermined value continues for a predetermined time.

If “NO” is determined in step S04, the step S04 is repeated. If “YES” is determined in step S04, a high-load EGR determination flag for indicating that the engine 1 is in the high-load condition is turned ON (step S05) and it is determined whether it is the deposit removal implementation timing or not (step S06). The deposit removal implementation timing is determined, depending on whether an accumulated running distance (or accumulated running time) from previous deposit removal implementation is equal to or more than a predetermined distance (or a predetermined time) or not.

If “NO” is determined in step S06, the control program is ended (step S13). If “YES” is determined in step S06, a deposit removal implementation timing determination flag for indicating that it is the deposit removal implementation timing is turned ON (step S07). Then, the process for retarding the ignition timing of the engine 1 and the process for decreasing the flow rate of cooling water by the cooling water flow control valve 8 are performed to carry out the removal of deposit (step S08) and it is determined whether the engine 1 is in a low-load condition or not (step S09). Here, the low-load condition refers to a condition in which a situation where the rotational speed of the engine 1 is less than a predetermined rotational speed and a filling efficiency is less than a predetermined value continues for a predetermined time.

If “YES” is determined in step S09, the high-load EGR determination flag is turned OFF (step S10), the deposit removal implementation timing determination flag is turned OFF (step S12) and then the control program is ended (step S13). If “NO” is determined in step S09, it is determined whether the accumulated running distance (or accumulated running time) after the removal of deposit is equal to or more than a predetermined distance (or a predetermined time) or not (step S11).

If “NO” is determined in step S09, the whole process returns to the removal of deposit (step S08). If “YES” is determined in step S10, the deposit removal implementation timing determination flag is turned OFF (step S12) and then the control program is ended (step S13).

As such, in the removal apparatus 9 for removing unburned deposits in the EGR flow passage, the control device 10 supplies a part of exhaust gas to the EGR flow passage 4 when it is determined that the temperature of cooling water is equal to or more than a predetermined temperature. Further, in a state where the exhaust gas is supplied to the EGR flow passage 4, the control device 10 implements the removal of deposit when it is determined that the engine 1 is in the high-load condition and when it is determined that it is the deposit removal implementation timing. The removal of deposit is implemented every time when an accumulated running distance (or accumulated running time) of a vehicle reaches a predetermined distance (or a predetermined time).

In this way, according to the removal apparatus 9 for removing unburned deposits in the EGR flow passage, since the deposit in the EGR flow passage 4 is removed in the high-load condition where the rotational speed of the engine 1 is high or the intake air amount thereof is large, the flow rate of the exhaust gas flowing through the EGR flow passage 4 is increased, as compared to a low-load condition of the engine 1. Accordingly, it is possible to effectively remove the deposit. Further, according to the removal apparatus 9 for removing unburned deposits in the EGR flow passage, it is possible to remove the deposit in the EGR flow passage 4 at a desired timing. The reason for implementing the removal of deposit in the high-load condition of the engine 1 is because the intake air amount of the engine 1 is increased, as compared to in the low-load condition of the engine 1. In this way, it is possible to increase the flow rate of exhaust gas returned to the intake passage 2, thereby improving the deposit removal efficiency.

Further, the deposit removal implementing means 17 implements at least one of a process for retarding the ignition timing of the engine 1 by the ignition timing retard means 14 or a process for decreasing the flow rate of cooling water supplied to the EGR cooler 6 by the cooling water flow control valve 8. In the above embodiment, the process for retarding the ignition timing and the process for decreasing the flow rate of cooling water are implemented to increase the temperature of the exhaust gas returned to the intake passage 2. The removal of deposit is implemented in a state where the temperature of EGR gas is increased by jointly implementing the process for retarding the ignition timing and the process for decreasing the supply flow rate of cooling water.

In this way, in order to remove deposit in the EGR flow passage 4, the deposit removal implementing means 17 jointly uses two types of temperature rise, that is, the temperature rise of exhaust gas owing to the process for retarding the ignition timing and the temperature rise of exhaust gas owing to decrease in a cooling efficiency of the EGR cooler 6 by the process for decreasing the flow rate of cooling water. By doing so, the temperature of the exhaust gas returned to the intake passage 2 can be rapidly increased so that the removal of deposit in the EGR flow passage 4 can be implemented in a short time.

The removal apparatus 9 for removing unburned deposits in the EGR flow passage does not implements the process for retarding the ignition timing but only implements the process for decreasing the flow rate of cooling water supplied to the EGR cooler 6 when the temperature of exhaust gas is equal to or more than a predetermined temperature (for example, approximately 700 to 800° C.) during a high-load determination. Further, the EGR gas flow control valve 5 and the cooling water flow control valve 8 are opened and closed by the control device 10. These control valves 5, 8 are opened in a fully opened state. However, the openness of these control valves may be varied depending on an operating condition (the temperature of cooling water or the rotational speed and intake air amount of the engine 1, etc.) of the engine 1.

The process for retarding the ignition timing by the ignition timing retard means 14 can increase the temperature within the EGR cooler 6 in a short time. Particularly, the process for retarding the ignition timing is effective to increase the temperature of exhaust gas in the vicinity of an exhaust gas inlet of the EGR cooler 6 and therefore the removal effect of deposit is high. Further, the process for decreasing the flow rate of cooling water supplied to the EGR cooler 6 by the cooling water flow control valve 8 is effective to lower the cooling efficiency of the EGR cooler 6 and thus it is possible to suppress supercooling of exhaust gas returned to the intake passage 2. Particularly, the process for decreasing the flow rate of cooling water supplied to the EGR cooler 6 is effective to increase the temperature of exhaust gas in the vicinity of an exhaust gas outlet of the EGR cooler 6.

According to the present invention, since the removal of deposit in the EGR flow passage is implemented in a high-load condition of an engine, the flow rate of the exhaust gas flowing through the EGR flow passage can be increased, as compared to a low-load condition of an engine. Accordingly, it is possible to effectively remove the deposit. Further, the present invention may be applied to various types of engines as a prime mover.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A removal apparatus for removing unburned deposits in an EGR flow passage of a vehicle, the EGR flow passage for returning a part of exhaust gas discharged from an engine to an intake part, the removal apparatus comprising:
the intake part configured to pass therethrough air supplied from the outside of the vehicle to the engine;
an exhaust part configured to pass therethrough the exhaust gas discharged from the engine;
the EGR flow passage branched from the exhaust pat and configured to return the part of the exhaust gas discharged from the engine to the intake part;
a water temperature sensor configured to detect a temperature of cooling water flowing in the engine;
a rotational speed sensor configured to detect a rotational speed of the engine;
an intake sensor configured to detect an intake air amount of the engine;
an EGR gas flow control valve provided on the EGR flow passage and configured to adjust a flow rate of the exhaust gas flowing through the EGR flow passage;
an EGR cooler provided on the EGR flow passage and configured to cool the exhaust gas flowing through the EGR flow passage;
a cooling water circulation passage configured to circulate a part of cooling water for cooling the engine between the EGR cooler and the engine;
a cooling water flow control valve provided on the cooling water circulation passage and configured to adjust a flow rate of the cooling water to the EGR cooler; and
a control device provided with a deposit removal implementing unit configured to implement removal of deposits as the unburned deposits in the EGR flow passage at a predetermined timing and configured to:
control the EGR gas flow control valve to flow the part of the exhaust gas through the EGR flow passage in a case where the control device determines that the temperature of the cooling water is equal to or more than a predetermined temperature; and
control the deposit removal implementing unit to implement the removal of the deposits in a case where the control device determines that the engine is in a high-load condition while the exhaust gas flows in the EGR flow passage and that it is a deposit removal implementation timing.

2. The removal apparatus according to claim 1,
wherein the control device is provided with an ignition timing retard unit configured to retard an ignition timing of the engine, and
wherein the deposit removal implementing unit is configured to implement at least one of a process of retarding the ignition timing of the engine by the ignition timing retard unit and a process of decreasing the flow rate of the cooling water to the EGR cooler by the cooling water flow control valve.
